(19) United States
(12) Patent Application Publication
(10) Pub. No.: US 2004/0207140 A1
(43) Pub. Date: Oct. 21, 2004

(54) Cutting board for food products

(76) Inventors: Tony A. Johnson, Dresser, WI (US); Wayne R. Johnson, Dresser, WI (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/419,552

(22) Filed: Apr. 21, 2003

(51) Int. Cl. B23Q 3/00

(52) U.S. Cl. 269/289 R

(57) ABSTRACT

Disclosed is a cutting board, comprising a body. The body defines a cutting surface. The cutting surface comprises a plurality of apertures extending through the body and a support structure separating each adjacent aperture of the plurality of apertures. The plurality of apertures allows fluid to drain from the cutting surface while the support structure grips the food item to minimize slippage on the surface during a cutting motion. The support structure includes one or more gripping edges for gripping a food item to resist horizontal shear forces exerted on the cutting surface. The plurality of apertures and the support structure define a substantially open matrix.

### FIELD OF THE INVENTION

The field of the present invention relates generally to cutting boards for food products and more specifically to drainable and slip-resistant cutting boards for use with minimally viscous food items such as filleting fish.

### BACKGROUND OF THE INVENTION

Cutting boards are commonly used to provide a suitable surface for food preparation. Cutting boards protect the underlying surface from being damaged while simultaneously protecting the knife or similar instrument from becoming dull too quickly. In addition, a cutting board can provide a portable surface that can be removed to a sink and cleaned separately and thoroughly, whereas other surfaces, such as a kitchen countertop, may not provide adequate protection and cannot be as quickly or easily cleaned.

A significant disadvantage of a conventional cutting board is the buildup of waste material and fluids generated by the food item, which may make the food preparation process less efficient and more dangerous. Efficiency is decreased due to the need to continually scrape debris and fluid away to maintain a clean and efficient cutting surface. U.S. Pat. No. 6,386,531 discloses one solution to the fluid drainage problem by providing a plurality of holes through the cutting board surface as well as a peripheral channel around the cutting surface that has additional drainage holes. A corresponding tray is used to catch the drained fluid and/or debris. This design, while allowing some drainage, does not provide any means for gripping the food item by the work surface.

The increased danger disadvantage presents itself due to the presence of fluid acting as a lubricant on the cutting surface, which causes the workpiece to slip. Usually, the person performing the cutting operation must secure the food item to minimize slippage. Placing one's hands within close proximity to a moving sharp instrument increases the likelihood of cuts. U.S. Pat. No. 5,860,641 provides for a slippage resistant cutting board for food products by teaching the use of numerous adjacently placed abrasive inserts to grip the food item during a cutting operation. This design presents the disadvantage of not being drainable or permitting debris to leave the cutting surface. Debris and juices may also become trapped between adjacent inserts, which make cleaning difficult.

The drainage and slippage issues present in the conventional art are particularly acute when a person performs a cutting motion that is parallel to the cutting surface. Such motion generates a significant shear force between the food item being cut and the surface of the cutting board. Horizontal cutting motions are very common when people fillet fish. An initial downward motion is used followed by a horizontal cut along the length of the fish. Knives used to fillet fish are often extremely sharp. Moreover, filleting fish produces a significant amount of debris and fluid. The fluid is most often slimy in consistency and very slippery. Therefore, filleting fish on conventional work surfaces can be difficult and often dangerous.

U.S. Pat. Nos. 6,200,212 and 4,017,063 each disclose clips used to hold a fish in place when scaling, cleaning or filleting. U.S. Pat. No. 5,116,279 disclosing a fish filleting apparatus for clamping a fish tail and strapping a fish head in place to aid filleting. Each of these patents recognizes the particular stabilization needs for fish filleting. However, clips and straps are inconvenient and only hold the food item at particular points, while allowing the remaining portion of the item to move. Consequently, there remains a continuing need to provide a cutting surface that provides for fluid drainage and minimal slipping of the food item being cut, particularly in the case of fish filleting.

### SUMMARY OF THE INVENTION

Disclosed is a cutting board, comprising a body. The body defines a cutting surface. The cutting surface comprises a plurality of apertures extending through the body and a support structure separating each adjacent aperture of the plurality of apertures. The plurality of apertures allows fluid to drain from the cutting surface while the support structure grips the food item to minimize slippage on the surface during a cutting motion. The support structure includes one or more gripping edges for gripping a food item to resist horizontal shear forces exerted on the cutting surface. The plurality of apertures and the support structure define a substantially open matrix.

### BRIEF DESCRIPTION OF THE FIGURES

FIG. 1 is a perspective view of a cutting board and corresponding drainage tray according to an embodiment of the present invention.

FIG. 2 is a top view of a cutting board according to an embodiment of the present invention.

FIG. 3 is a top view of a cutting board according to an embodiment of the present invention.

FIG. 4A is a partial top view of a matrix configuration for a cutting board according to an embodiment of the present invention.

FIG. 4B is a partial top view of a matrix configuration for a cutting board according to an embodiment of the present invention.

FIG. 4C is a partial top view of a matrix configuration for a cutting board according to an embodiment of the present invention.

FIG. 4D is a partial top view of a matrix configuration for a cutting board according to an embodiment of the present invention.

FIG. 4E is a partial top view of a matrix configuration for a cutting board according to an embodiment of the present invention.

FIG. 4F is a partial top view of a matrix configuration for a cutting board according to an embodiment of the present invention.

FIG. 5A is a partial side view of a lattice profile for the matrix of a cutting board according to an embodiment of the present invention.

FIG. 5B is a partial side view of a lattice profile for the matrix of a cutting board according to an embodiment of the present invention.

FIG. 5C is a partial side view of a lattice profile for the matrix of a cutting board according to an embodiment of the present invention.

FIG. 5D is a partial side view of a lattice profile for the matrix of a cutting board according to an embodiment of the present invention.

FIG. 5E is a partial side view of a lattice profile for the matrix of a cutting board according to an embodiment of the present invention.

FIG. 5F is a partial side view of a lattice profile for the matrix of a cutting board according to an embodiment of the present invention.

FIG. 6 is a perspective view of a cutting board in combination with a table according to an embodiment of the present invention.

FIG. 7 is a side view of a cutting board in combination with a table according to an embodiment of the present invention.

### DETAILED DESCRIPTION OF THE PREFERRED EMBODIMENTS

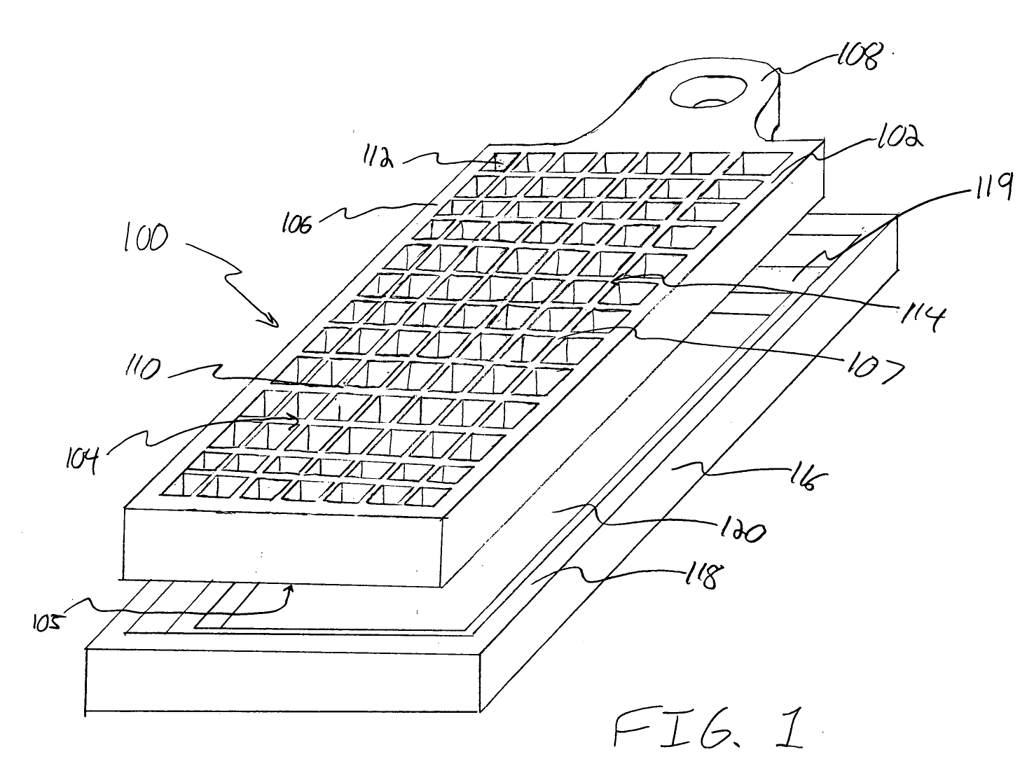

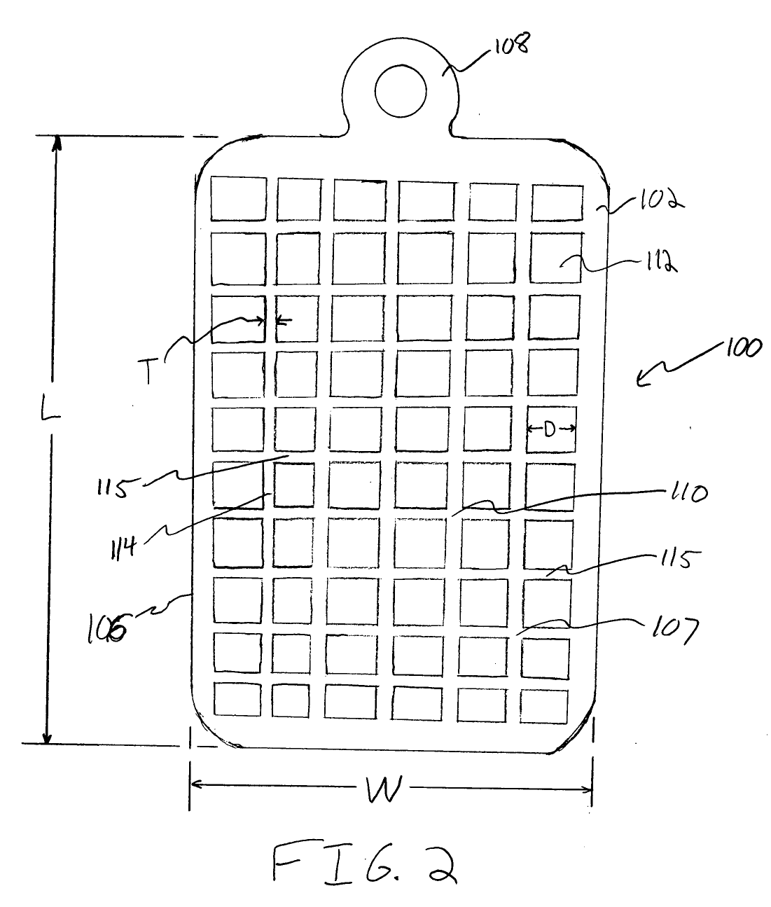

Referring to FIGS. 1 and 2, a generally rectangular shaped cutting board 100 is shown. It should be recognized that the cutting board 100 may take many shapes, including, but not limited to circular, triangular, square, polygonal arcuate and irregular without departing from the scope of the present invention. The cutting board 100 comprises a body 102 with a top side 104, a bottom side 105 and a perimeter 106 therearound. The body 102 also has a length L and a width W. One or both of the top 104 and bottom 105 sides of the cutting board 100 may comprise a cutting surface 107. A handle 108 may optionally be provided to the device 100 to aid in holding and storage.

The cutting surface 107 comprises a matrix or lattice portion 110 of openings or apertures 112 extending from the top surface 104 through the body 102. The lattice portion 110 comprises a plurality of widthwise 114 and lengthwise 115 members with the apertures 112 defined there between. The plurality of widthwise 114 and lengthwise 115 members have a thickness T. The apertures 112 allow fluids to pass through the cutting surface 107 without accumulating thereon. The sizing and pattern of the lattice portion 110 is selected to support the food product on the lattice 114 while still permitting the fluid to drain.

One embodiment of the invention comprises a rectangular body 102 an aperture 112 width dimension D of 1.2 mm and thickness T for the plurality of widthwise 114 and lengthwise 115 members of 0.2 mm. The area of the lattice portion comprising the apertures is approximately 60% in this embodiment.

The substantially open lattice 110 of the present invention has been found to grip the food item while permitting full drainage in addition to removal of small debris. Gripping portions 144 are positioned at each aperture. The food item penetrates the plane of the cutting surface 107 and is gripped by the gripping portions 144 of the lattice 114.

A tray 116 may also be provided that conforms to the shape of the cutting board 100. The tray 116 comprises a tray body 118 having a support ledge 119 and a recess 120 configured to receive the board 100. The ledge 119 supports the cutting board 100 when placed in the tray 116. The recess 120 permits juices and debris drained off the cutting surface 107 to be retained in the recess 120. Such retention of juices and debris minimize contamination of countertops, tables or other work surfaces. The juices and debris may then be easily discarded.

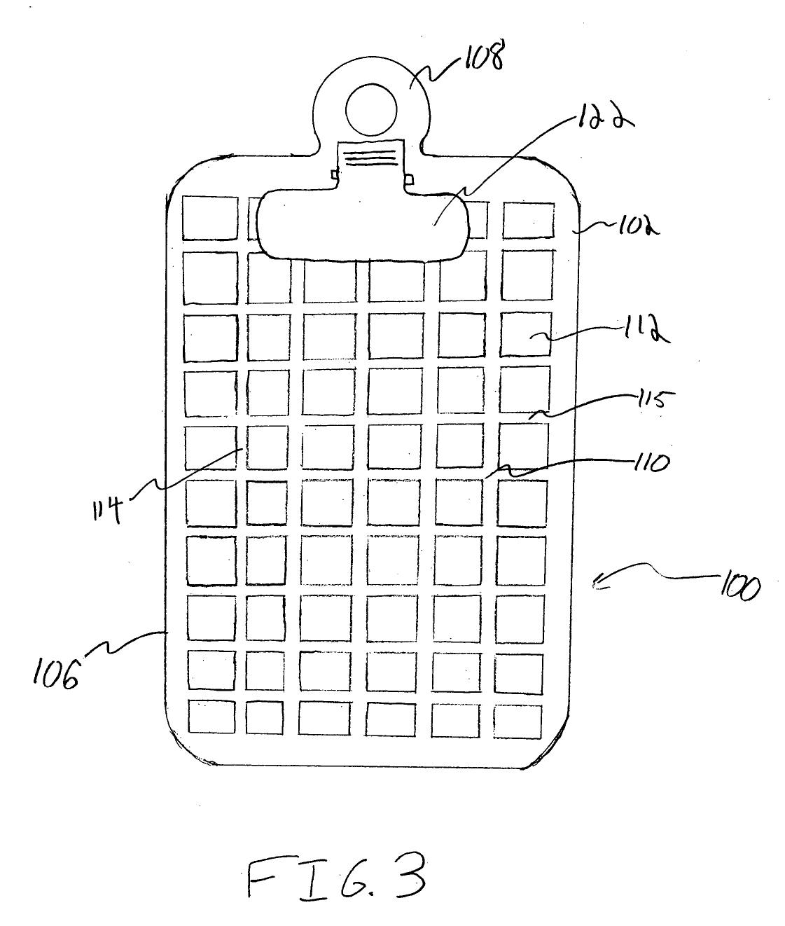

Referring to FIG. 3, another embodiment of the present invention is shown. In this embodiment, the cutting board 100 is further provided with a retention clip 122 thereon. The clip uses a resilient means, such as a spring, to clamp a food item against the cutting surface 107. In particular applications where the shear forces are very high, the clip 122 adds additional stability to the food item being cut.

In another embodiment, the board 100 may be provided with supports to allow its suspension within a sink. This will allow fluids to drain directly. It will also facilitate washing of the food item before, during or after a cutting operation.

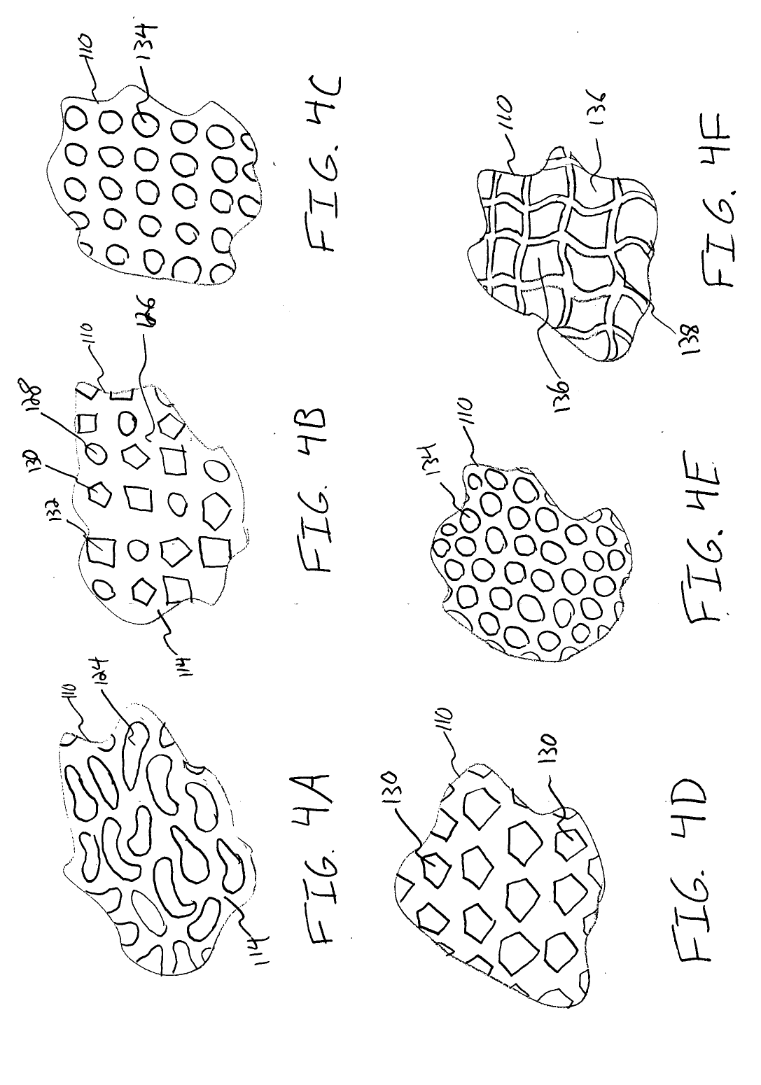

Referring to FIGS. 4A through 4F, additional configurations for the lattice 110 are shown. FIG. 4A illustrates irregular shaped apertures 124 provided to a work surface. The resulting support structure is correspondingly irregular. FIG. 4B illustrates a repeating pattern of shapes 126, such as circles 128, pentagons 130 and squares 132. FIG. 4C illustrates a conventional lattice 110 of circular shapes 134. FIG. 4D illustrates a lattice 110 of pentagons 130. FIG. 4E illustrates a densely packed lattice 110 of circular shaped 134 apertures; although various polygonal shapes may be alternatively employed. FIG. 4F illustrates a lattice 110 of irregular shaped apertures 136 defined by arcuate members 138. Those having skill in the art will recognize that the lattice 110 may take any shape consistent with having a substantially open lattice area that permits the food item to be gripped by the gripping portions. A lattice portion not being substantially open will result in the food item slipping upon the generally closed surface as if the surface were completely closed.

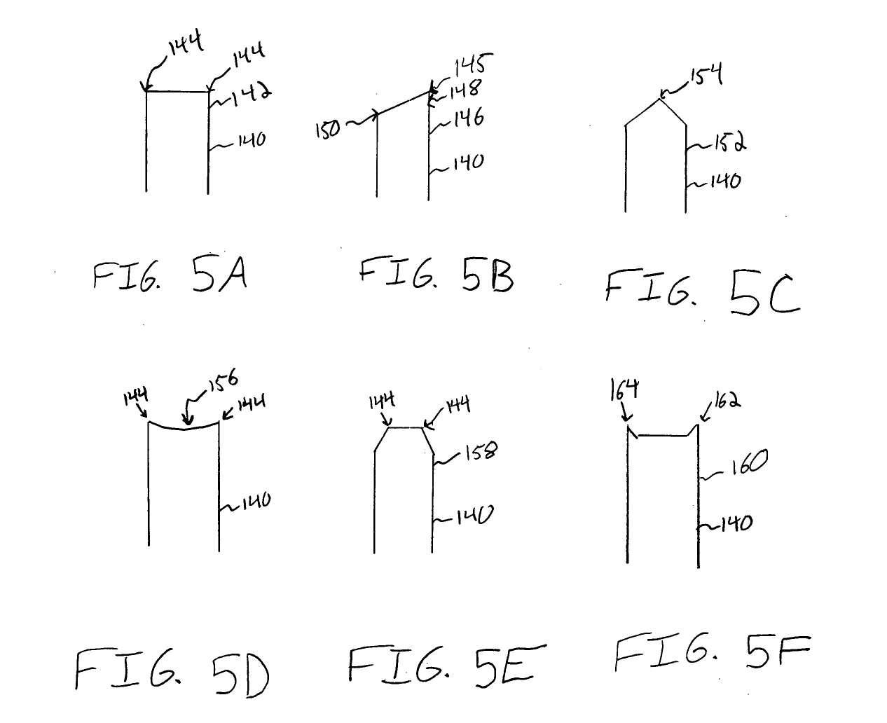

FIGS. 5A through 5F illustrate different structural profiles 140 for the lattice 114 according to embodiments of the present invention. FIG. 5A illustrates a generally rectangular profile 142. The generally rectangular profile 142 presents gripping portions 144, which aid in gripping of the food item. FIG. 5B illustrates a singular bevel profile 146, which presents a larger portion 145 on a first side 148 with respect to a second side 150. FIG. 5C is double beveled 152, which presents a central gripping portion 154. FIG. 5D illustrates a central arcuate depression 156, which enhances the grip of the gripping portions 144 with respect to the generally rectangular embodiment 142 of FIG. 5A. FIG. 5E illustrates a multi-planar profile 158 that presents a plurality of gripping portions 144. FIG. 5F illustrates an inverted multi-planar profile 160 that presents first 162 and second 164 gripping portions. Those having skill in this art will recognize that the lattice 114 may be provided with any side profile that presents one or more gripping portions 144, without departing from the scope of the present invention.

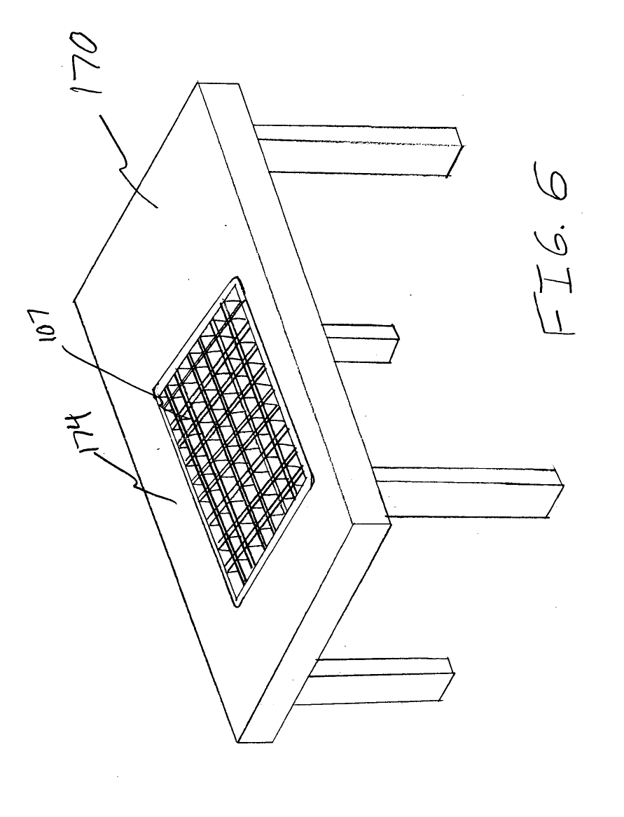

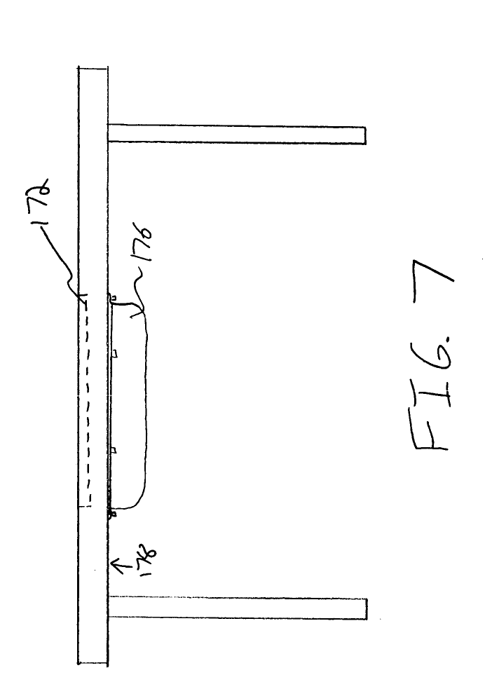

Referring to FIGS. 6 and 7, another embodiment of the present invention is shown. In this illustrative embodiment, the cutting board 100 is integrated into a table 170. The table 170 includes a recess 172 for receiving the board. The recess 172 is preferably the same depth as the board so as to provide for a flush meeting of adjacent table 174 and board surfaces 104. A receptacle or catch basin 176 is provided to the bottom 178 of the table 170 for collecting drained fluids and/or debris. The receptacle 176 is removable for discarding the fluid and debris. Those having skill in the art will recognize that the cutting board 100 of the present invention may be incorporated into other devices without departing from the scope of the present invention.

The cutting board 100 contemplated by the present invention is molded of a plastic according to one embodiment. The board 100 may be formed by an injection molding procedure as a single part. Alternatively, the lattice portion may be fastened to a separately formed support structure. Persons having skill in the art will recognize that the board 100 may be constructed of other materials, such as wood, without departing from the scope of the present invention.

In use, a food item to be acted upon, such as a fish to be filleted, is placed upon the cutting surface 107. The surface of the food item contacting the lattice 110 is gripped by the gripping portions 144 of the lattice 114 due to slight penetration of the plane of the cutting surface 107 by the food item. The person then performs the cutting action. Fluid generated by the food item before, during and after the procedure drains away from the food item through the plurality of apertures 112 in the body 102 of the cutting board 100. Moreover, small debris may also fall away from the cutting surface 107 though the apertures 112. The fluid and debris may be collected in the corresponding tray or receptacle 116, if desired by the user. Finally, the board 100 may be washed in a conventional manner, such as in a dishwasher.

The embodiments described herein are intended to be illustrative and not limiting. Additional embodiments are within the claims. Although the present invention has been described with reference to particular embodiments, one skilled in the art will recognize that changes may be made in form and detail without departing from the spirit and the scope of the invention.

1. A cutting board for food items, the cutting board comprising:
a body having a top side, a bottom side, and a lattice portion;
the lattice portion having an area with an upwardly facing cutting surface and a multiplicity of apertures extending from the upwardly facing cutting surface through the body, the apertures having greater than 50% of the area of the lattice portion, the lattice portion further comprising a plurality of gripping portions positioned at each aperture for securing the food items to be cut upon the cutting board.

2. The cutting board of claim 1, wherein the gripping portions are defined by a corner defined in part by the upwardly facing cutting surface at each aperture.

3. The cutting board of claim 1, wherein the cutting board has a length and a width and the lattice portion comprises a plurality of widthwise and lengthwise members and the multiplicity of apertures are defined by said widthwise and lengthwise members.

4. The cutting board of claim 3, wherein the apertures are rectangularly shaped at the upwardly facing cutting surface and are defined by the widthwise members and lengthwise members.

5. The cutting board of claim 3, wherein the plurality of widthwise and lengthwise members have a thickness of less than 0.3 millimeters.

6. The cutting board of claim 1, wherein the apertures comprise greater than 60% of the area of the lattice portion.

7. The cutting board of claim 1, wherein the body is generally rectangular shaped.

8. The cutting board of claim 1, further comprising a handle provided to the body.

9. The cutting board of claim 1, further comprising supports operably connected to the body for supporting the cutting board in a sink.

10. A cutting board comprising:
a body having a top side, a bottom side, and a lattice portion;
the lattice portion comprising an upwardly facing cutting surface, a plurality of widthwise and lengthwise members and a multiplicity of apertures defined by said widthwise and lengthwise members, the multiplicity of apertures extending from the upwardly facing cutting surface through the body, the plurality of widthwise and lengthwise members having a thickness of less than 0.3 millimeters, the lattice portion further comprising a plurality of gripping portions positioned at each aperture for securing the food items to be cut upon the cutting board.

11. The cutting board of claim 10, wherein the apertures have greater than 50% of the area of the lattice portion.

12. The cutting board of claim 10, wherein the apertures have greater than 59% of the area of the lattice portion.

13. The cutting board of claim 10, wherein the thickness of the plurality of widthwise and lengthwise members is between 0.15 and 0.25 millimeters.

14. The cutting board of claim 10, further comprising supports operably connected to the body for supporting the cutting board in a sink.

15. A system for cutting food items, the system comprising:
a tray having a recess configured to hold a quantity of fluid in the recess; and
a cutting board provided to the recess, the cutting board comprising:
a body having a top side, a bottom side, and a lattice portion;
the lattice portion having an area with an upwardly facing cutting surface and a multiplicity of apertures extending from the upwardly facing cutting surface through the body, the apertures having greater than 50% of the area of the lattice portion, the lattice portion further comprising a plurality of gripping portions positioned at each aperture for securing the food items to be cut upon the cutting board.

16. The system of claim 13, wherein the tray includes a ledge for supporting the cutting board within the recess.

17. A system for cutting food items, the system comprising:
a work surface having a recess defined therein; and
a cutting board provided to the recess, the cutting board comprising:
a body having a top side, a bottom side, and a lattice portion;
the lattice portion having an area with an upwardly facing cutting surface and a multiplicity of apertures extending from the upwardly facing cutting surface through the body, the apertures having greater than 50% of the area of the lattice portion, the lattice portion further comprising a plurality of gripping portions positioned at each aperture for securing the food items to be cut upon the cutting board.

18. The system of claim 15, further comprising a fluid receptacle operably connected to the work surface for retaining fluid drained from the cutting board.

19. A method for minimizing horizontal slippage of a food item during a cutting operation, the method comprising the steps of:
placing a food item on a cutting surface defined by a body, the body having a lattice portion having an area with an upwardly facing cutting surface and a multiplicity of apertures extending from the cutting surface through the body, the apertures having greater than 50% of the area of the lattice portion;
gripping the food item with a plurality of gripping portions positioned at each aperture; and
draining fluid from the cutting surface through the multiplicity of apertures.

20. The method of claim 19, further comprising the step of transferring the drained fluid to a receptacle.

21. The method of claim 19, further comprising the step of placing the cutting board in a recess formed in a work surface.

22. The method of claim 19, further comprising the step of suspending the cutting board in a sink.
